(19) United States
(12) Patent Application Publication
(10) Pub. No.: US 2007/0114414 A1
(43) Pub. Date: May 24, 2007

(54) Energy signal detection device containing integrated detecting processor

(76) Inventors: James Parker, Temple City, CA (US); Randall Wang, Temple City, CA (US)

Correspondence Address: Raymond Y. Chan, 108 N. Ynez Ave., #128, Monterey Park, CA, 91754, US

(21) Appl. No.: 11/360,012

(22) Filed: Feb. 21, 2006

Related U.S. Application Data
(63) Continuation-in-part of application No. 11/282,362, filed on Nov. 18, 2005.

(51) Int. Cl. G01J 5/00

(52) U.S. Cl. 250/338.3

(57) ABSTRACT

An energy signal detection device includes a pyroelectric sensor sensing an infrared radiation within a detecting area, a microprocessor, and an integrated detecting processor. The infrared radiation as an input signal is converted into a DC signal as an output signal having a real signal with low frequency and a noise signal mixed therewith. The microprocessor includes an ADC converter electrically connected with the pyroelectric sensor, wherein the microprocessor is arranged to receive the DC signal for data processing. The integrated detecting processor is adapted for stripping out the DC signal from the pyroelectric sensor to control a DC level of the DC signal, such that the real signal is allowed to be processed in the microprocessor without data overflowing.

### CROSS REFERENCE OF RELATED APPLICATION

This is a Continuation-In-Part application of a non-provisional application, application Ser. No. 11/282,362, filed Nov. 18, 2005.

### BACKGROUND OF THE PRESENT INVENTION

1. Field of Invention

The present invention relates to an integrated detecting processor, and more particularly to an enhanced energy signal detection device containing the integrated detecting processor for minimizing false alarms and maximizing the sensitivity, performance and reliability of the energy signal detecting device.

2. Description of Related Arts

The increasing number of false alarms is causing the industry to loose credibility with government and private enforcement agencies. A trend of no response policies and heavy fines for false burglary alarms is in place already for many jurisdictions. Some false alarms are user related, but the majority of false alarms originate from Passive Infra Red (PIR) detectors in use today are low end, low cost units.

Motion detector is a kind of energy signal detection device uses Passive Infra-Red (PIR) technology to detect movement of body heat to activate the alarm in the event of an intrusion. The conventional motion sensor, such as PIR detector, usually comprises a sensor casing, a sensing element, fresnel lens directing infrared energy onto the sensing element so as to detect a movement of a physical object within a detecting area, and a microprocessor (which may comprise an analog-to-digital converter) for compiling an electrical signal outputted from the sensing module so as to recognize a physical movement in the detecting area.

Traditional detector uses a pyroelectric sensing module as the sensing element that has a very low analog signal level output. A low but still usable AC signal is in the order of 1 to 2 mVp-p with a much larger ˜10 mVp-p of high frequency noise component, all of which rides on a DC component of 400 mV to 2000 mV, that will change with temperature, aging and also part to part. The usable frequency component of this signal is from 0.1 Hz to 10 Hz. A fresnel lens directs infrared energy onto this sensing element. The element's output is traditionally fed into a tight band pass filter stage to reduce high frequency noise and strip the DC element that the signal rides on. It is then fed into a high gain stage (˜72 db) so that the signal can be used by either discreet components or by a microcontroller to make decisions and act upon them.

A drawback of the traditional detector is the filter and gain stage. By filtering the signal, it removes information that is sometimes critical to being able to make a reliable decision. Any signal discontinuity between the element and the filter stage due to external electrical factors or forces will lock no different then a low level infrared energy signature at the output of the gain stage. This impacts the detectors maximum range and pet immunity reliability. The only information processing methods available after these stages are to do root mean squared energy under the curve measurements, to determine if the energy exceeds a threshold limit. Older detecting processors do not have the processing power for more elegant techniques to be used. There is also frequency component as well, and it will vary from 0.1 Hz to 10 Hz and it will change with movement. There is often not even a single full cycle of any given frequency to use.

With such limitations due to the signal pre-conditioning, almost all conventional detectors include a “pulse count” feature that basically admits that the detector can and will false under normal operating conditions. Higher end, more expensive, detectors can include a micro wave sensor where it needs one technology to confirm the other in the decision making process.

More specifically, the pyroelectric sensing module usually comprises a signal input to receive an infrared signal created by infrared energy from the detecting area, a signal output adapted for producing a predetermined level of output signal in responsive to the infrared signal, wherein the output signal is fed into the microprocessor for further analysis for recognizing the physical movement in the detecting area.

A major problem for the conventional motion detector is that the output signal of the pyroelectric sensing module (+DC offset) is very low, typically in the order of milli-volts, so that the output signal corresponding with actual physical movement within the detecting area is easily superseded by surrounding noise or other factors which may affect the infrared energy received by the pyroelectric sensing module. As a result, the overall performance of the motion sensor will be inaccurate.

In order to cater for this problem, the motion detector may further comprise a signal filtering circuitry and a signal amplifying circuitry electrically connected with the pyroelectric sensing module, wherein the output signal of the pyroelectric sensing module is fed into the signal filtering circuitry and the signal amplifying circuitry which are arranged to filter noise signal and amplify the remaining signal respectively for further processing of the output signal of the pyroelectric sensing module. Therefore, some signals are removed from the output signal when it has passed through the signal filtering circuitry and the signal amplifying circuitry.

A persistent problem with this signal filtering and signal amplifying strategies is that it is possible that those portions of signal which reflect the actual physical movement, as opposed to surrounding noise, may be mistakenly removed by the signal filtering circuitry so that actual physical movement within the detecting area may not be successfully detected. On the other hand, those portions of output signal which reflect surrounding noise or any other environmental factors may be mistakenly interpreted as an actual physical movement in the detecting area so that false alarm may be produced as a result.

Another problem of this kind of conventional motion detector is that it is usually expensive because of the various circuitries which are incorporated into the motion detector for catering the above-mentioned problems.

One way to overcome these design limitations is to feed the signal directly into a DSP processor. A DSP processor is capable of working very well with low signal levels, and high frequency components. Aside from significant cost increases with this approach, it still has its' technical drawbacks as well. For one, DSP's consume higher power than is typically allotted for a PIR design.

A DSP processor is designed to work on signals in the frequency domain. It is uniquely tailored to be able to accomplish Fourier math analysis of signals at high frequencies. The problem here is this signal exists predominantly in the time domain.

There is no consistent signal frequency to analyze. Also the slower in frequency the signal is the more storage and horsepower will be required by the processor to be able to detect it. One would want to digitally filter the high frequency noise component so as to detect discontinuities. This means that it needs to super sample for durations of time in the seconds to be able to detect the low frequency signal required. This then becomes as issue for storage of the samples to be worked on. Increase the storage, then it increases the cost yet again.

### SUMMARY OF THE PRESENT INVENTION

A main object of the present invention is to provide an enhanced energy signal detection device containing an integrated detecting processor, which not only improves its sensitivity, performance and reliability, but also reduces false alarms and its production cost.

Another object of the present invention is to provide an integrated detecting processor of an enhanced energy signal detection device, which is distinguishable to noise and real signals.

Another object of the present invention is to provide an enhanced energy signal detection device for sensing physical movement in a detecting area, wherein the energy signal detection device comprises an integrated detecting processor which is adapted to supplement a regulated DC signal to an output signal of a pyroelectric sensing element in the energy signal detection device so as to improve the quality of those portions of output signals corresponding with an actual physical movement within the detecting area for maximizing an overall performance of the energy signal detection device and overcoming the above-mentioned problems of conventional motion detectors.

Another object of the present invention is to provide an energy signal detection device containing an integrated detecting processor, which is adapted to supplement a specifically controlled DC signal to an output signal of the pyroelectric sensing element in the energy signal detection device so that a microprocessor of the energy signal detection device is supplied with an optimal level of electrical signal for performing accurate and sensitive measurement of the physical movement within the detecting area.

Another object of the present invention is to provide an integrated detecting processor of an energy signal detection device controlled by a specifically designed algorithm, so that the integrated detecting processor is capable of adapting to a wide range of situations (such as DC signal deterioration by the pyroelectric sensing element) to maintain the optimal level of electric signal supplied to the microprocessor.

Another object of the present invention is to provide an energy signal detection device which can substantially overcome the above-mentioned problems without utilizing complicated mechanical or electrical components, so as to minimize the manufacturing cost as well as the ultimate selling price of the present invention.

Accordingly, in order to accomplish the above objects, the present invention provides an energy signal detection device, comprising:

a pyroelectric sensor detecting energy radiation directed thereonto as an input signal which is converted into a DC signal as an output signal through the pyroelectric sensor, wherein the DC output signal has a real signal with low frequency and a noise signal mixed therewith;

a microprocessor, which comprises an ADC converter, being arranged to receive the DC signal from the pyroelectric sensor for data processing so as to determine whether a target locating within the detecting area; and

an integrated detecting processor stripping out the DC signal from the pyroelectric sensor to control a DC level of the DC signal, such that the real signal is allowed to be processed in the microprocessor without data overflowing.

In other words, the integrated detecting processor allows the microprocessor to use a small signal across a dynamic range (an entire ADC dynamic operating range) of the microprocessor without the DC level either using up a portion of the ADC dynamic operating range or causing the DC level plus the small signal to overflow the ADC dynamic operation range.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of an energy signal detection device according to a preferred embodiment of the present invention.

FIG. 2 is a circuit diagram of the energy signal detection device according to the above preferred embodiment of the present invention.

FIG. 3 is a perspective view of the energy signal detection device according to the above preferred embodiment of the present invention.

FIG. 4 is a method of sensing motion by the energy signal detection device according to the above preferred embodiment of the present invention.

FIG. 5A is a chart illustrating A/D samples from pyro element when there is no signal.

FIG. 5B is a chart illustrating A/D samples from pyro element when there is small signal.

FIG. 6 is a chart illustrating the control limits.

FIG. 7 is a chart illustrating the 1000-2000 sample window and the 4000-5000 sample window.

FIG. 8 is a chart illustrating discontinuity in the 1000-2000 sample window.

FIG. 9 is a schematic diagram of the energy signal detection device according to the above preferred embodiment of the present invention.

### DETAILED DESCRIPTION OF THE PREFERRED EMBODIMENT

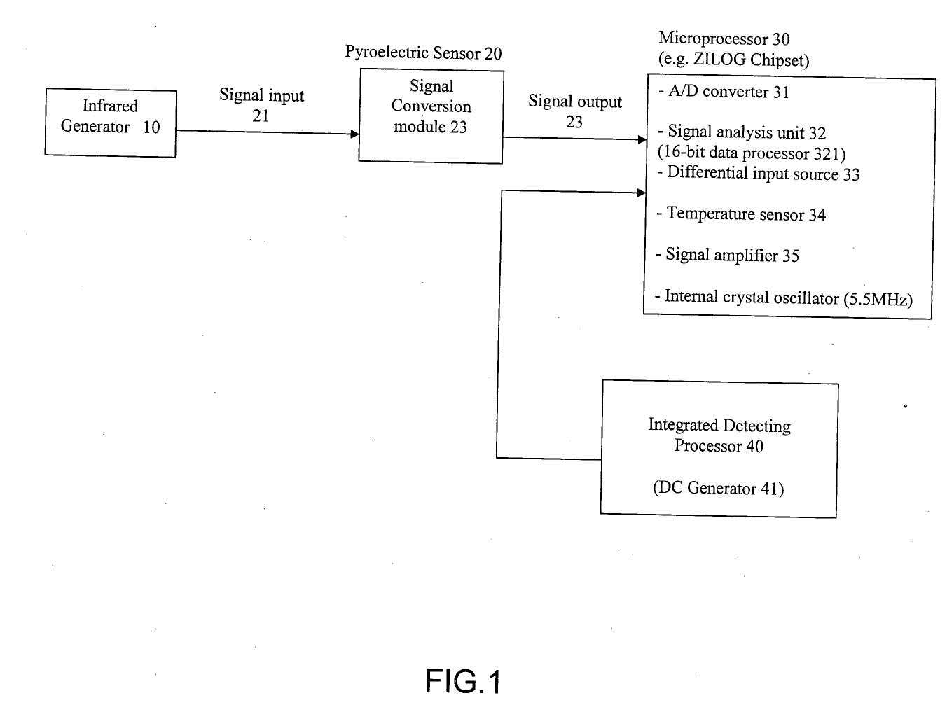

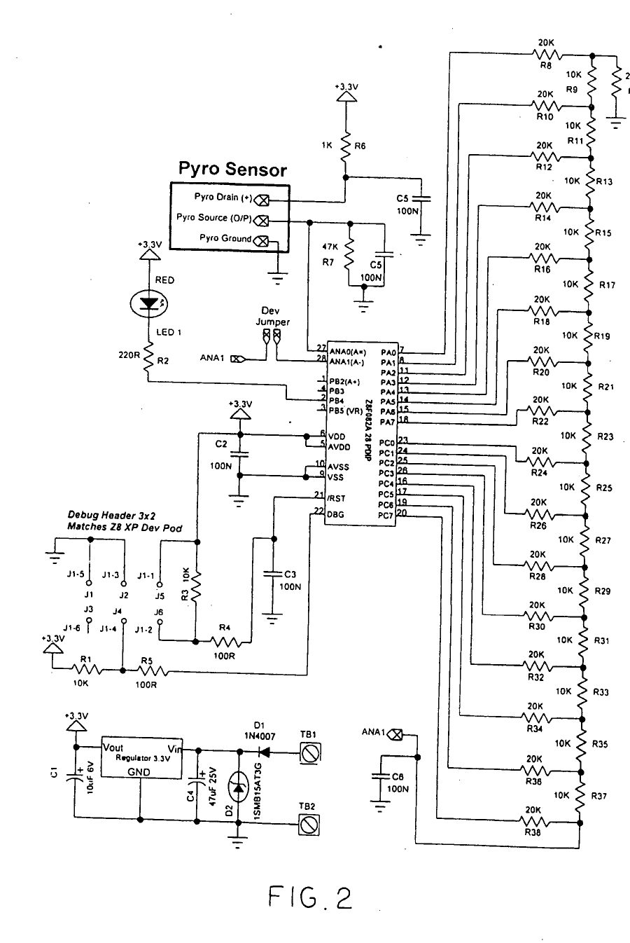

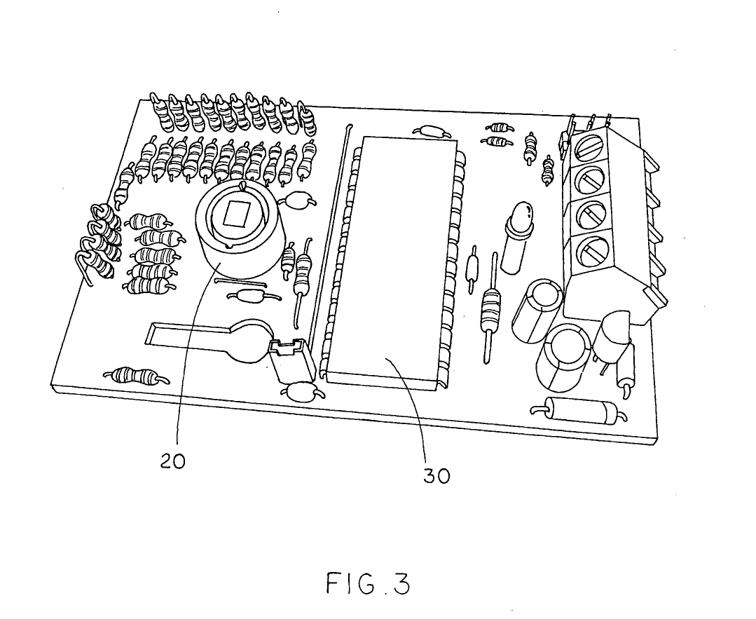

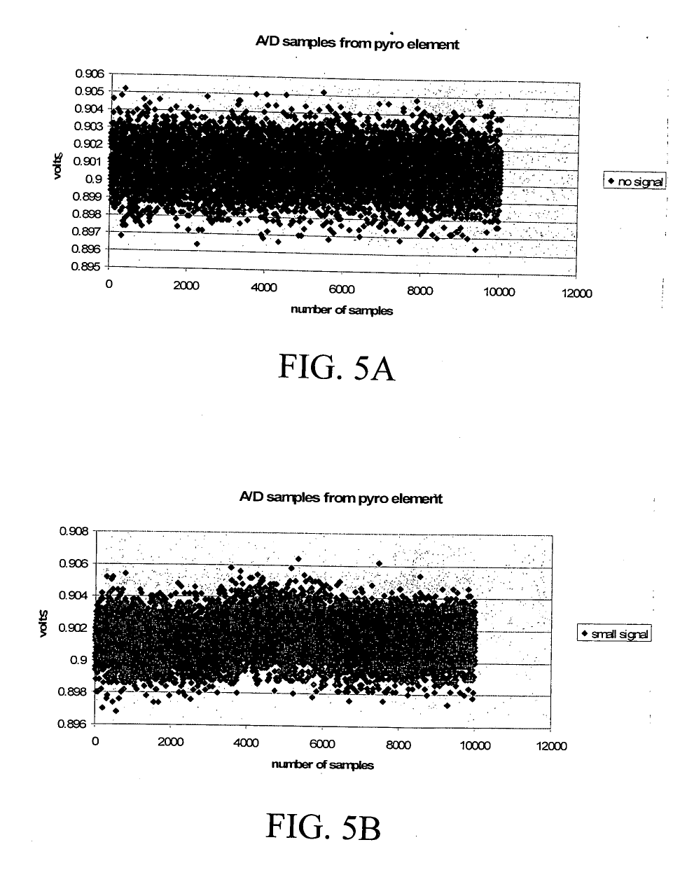

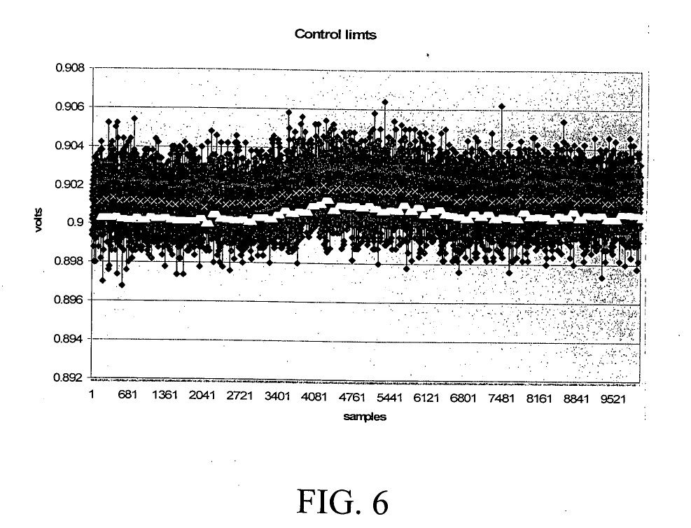

Referring to FIG. 1 to FIG. 3, Fig, 5A, FIG. 5B, FIG. 6 to FIG. 9 of the drawings, an energy signal detection device, such as a PIR motion detector, according to a preferred embodiment of the present invention is illustrated. The energy signal detection device can detect various kinds of energy such as smoke, temperature, gas, and light.

According to the present invention, the energy signal detection device is embodied as an infrared sensor which comprises a pyroelectric sensor 20 which is a pyroelectric sensing element sensing an energy radiation (i.e. the infrared radiation 10 according to the preferred embodiment) within a detecting area, a microprocessor 30 and an integrated detecting processor 40.

The infrared energy 10 is directed onto the pyroelectric sensor 20, wherein the infrared radiation 10 as an input signal is converted into a DC signal as an output signal through the pyroelectric sensor 20, wherein the DC output signal has a real signal with low frequency and a noise signal mixed therewith.

Thus, the pyroelectric sensor 20 has a signal input 21 adapted to receive infrared energy 10, a signal conversion module 22 electrically connected with the signal input 21 for converting the infrared energy 10 to the DC output signal, and a signal output 23 electrically connecting with the signal conversion module 22 for outputting the DC output signal.

The microprocessor 30, such as a ZLOG chipset, comprises an ADC converter 31 electrically connected with the pyroelectric sensor 20, wherein the microprocessor 30 is arranged to receive the DC signal for data processing so as to determine whether a target is locating within the detecting area.

Thus, the microprocessor 30 is electrically connected with the pyroelectric sensor 20 to receive the pyroelectric DC signal for interpreting the pyroelectric DC signal so as to measure the corresponding physical motion in the detecting area.

The integrated detecting processor 40, which is electrically connected with the microprocessor 30, is adapted for stripping out the DC signal from the pyroelectric sensor 20 to control a DC level of the DC signal, such that the real signal corresponding with the physical movement in the detecting area is allowed to be accurately processed in the microprocessor 30 without data overflowing.

In other words, the integrated detecting processor 40 is electrically connected with the microprocessor 30, wherein the integrated detecting processor 40 is programmed to feed an offset DC signal to the microprocessor 30, wherein the offset DC signal is intelligently adjusted to correspond with the DC output signal in such a manner to optimize an overall signal input to the microprocessor 30, so that the microprocessor 30 is supplied with an optimal DC input signal for performing accurate manipulation as to the physical motion in the detecting area.

According to the preferred embodiment of the present invention, the integrated detecting processor 40 comprises a DC generator 41 having the same DC resolution of the microprocessor 30.

The pyroelectric sensor 20 is adapted to generate the DC output signal which corresponds to an infrared energy differential between the outgoing infrared radiation and the received infrared radiation.

On the other hand, the microprocessor 30 comprises a signal analysis unit 32 electrically connecting with the ADC converter 31 for statistically analyzing the DC signal, wherein the signal analysis unit statistically collects a plurality of sample data from the DC signal via a time domain to dynamically control the sample data by itself, wherein a control range of the DC signal is determined from the sample data in such a manner that when the sample data falls within the control range, the sample data is considered as the noise signal to be discarded from the DC signal, so as to accurately process the real data with low frequency in the DC signal in the ADC converter 31. All of the signal elements within the control limits comprise the steady state random noise and environment energy level. It's when the data/signal elements fall outside the control limits that we have a real IR change, or detection of motion.

In other words, the integrated detecting processor 40 allows the microprocessor 30 to use a small signal across a dynamic range (an entire ADC dynamic operating range) of the microprocessor 30 without the DC level either using up a portion of the ADC dynamic operating range or causing the DC level plus the small signal to overflow the ADC dynamic operation range. That is the integrated detecting processor 40 allows the microprocessor 30 to use a small signal across a dynamic range (an entire ADC dynamic operating range) of the microprocessor 30 without the DC level either using up a portion of the ADC dynamic operating range or causing the DC level plus the small signal to overflow the ADC dynamic operation range.

The microprocessor 30 further comprises a differential input source 33 electrically coupling with the pyroelectric sensor 20 to measure a difference between the two signals from the DC generator 41 and the pyroelectric sensor 20.

The microprocessor 30 further comprises a temperature sensor 34 for determining a temperature of the target with respect to an ambient temperature so as to control a sensitivity of the microprocessor 30. The microprocessor 30 further comprises a signal amplifier 35 amplifying the DC signal with the real signal before sending to the ADC converter 31.

The microprocessor 30 is preferably embodied as a ZLOG chip set (1 K of RAM and 8 K of ROM) which comprises the ADC converter 31 and the signal amplifier 35, wherein the DC output signal is fed into the microprocessor 30 and is amplified and converted into digital signal which is then further manipulated to reflect the physical motion of the detecting area.

The microprocessor 30 further comprises an internal 5.5 Mhz crystal oscillators, wherein the infrared energy 10 of the radiation is affected by the ambient temperature, signal analysis taken place at the microprocessor 30 need to be adjusted to take into account any change in ambient temperature as detected by the temperature sensor 34.

The microprocessor 30 has a positive terminal and a negative terminal for signal input, wherein the positive terminal is electrically connected with the pyroelectric sensor 20, while the negative terminal is electrically connected with the integrated detecting processor 40, wherein the DC output signal is negated by the offset DC signal generated from the integrated detecting processor 40 for constituting the differential input source 33 so as to optimize the DC output signal feeding into the microprocessor 30 for optimally accurately calculating the physical motion with the detecting area.

According to the preferred embodiment of the present invention, the signal analysis unit 32 comprises a data processor 321 statistically determining the control range to form an upper control limit and a lower control limit of the data, wherein a range between the upper and lower control limits is determined in term of numbers of standard deviation from the sample data within the time domain.

The data processor 321 is preferably an n-bit processor statistically takes n sample data at one time to form a single sample for data analysis, so as to increase a resolution of the ADC converter 31 by over sampling (e.g. a 16-bit data processor 321).

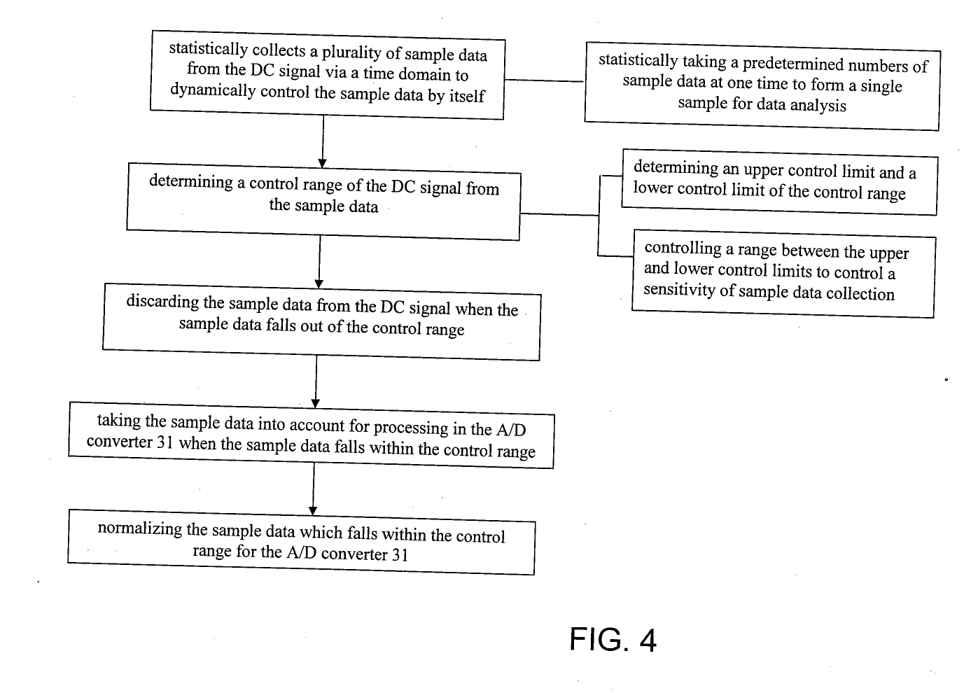

In the energy signal detection device as described above, the DC signals are analyzed for the ADC converter 31, referring to FIG. 4 of the drawings, wherein the method comprises the steps of:

(a) statistically collects a plurality of sample data from the DC signal via a time domain to dynamically control the sample data by itself;

(b) determining a control range of the DC signal from the sample data;

(c) discarding the sample data from the DC signal when the sample data lies within the control range; and

(d) taking the sample data into account for processing in the ADC converter 31 when the sample data falls out of the control range, i.e. data analyzed for movement detection is data that falls out of the established control limits.

Step (a) further comprises a step of statistically taking a predetermined numbers of sample data at one time to form a single sample for data analysis, so as to increase a resolution of the ADC converter 31 by over sampling.

Step (b) comprises a step of determining an upper control limit and a lower control limit of the control range, wherein a range between the upper and lower control limits is determined in term of numbers of standard deviation from the sample data within the time domain.

Thus, step (b) further comprises a step of controlling a range between the upper and lower control limits to control a sensitivity of sample data collection.

In order to effectively analyzing the signal detected by the energy signal detection device of the present invention, the method further comprises a step of normalizing the sample data which falls within the control range for the ADC converter 31. As such, the sample date can be normalized to be further processed for interpreting the detected motion within the detecting area. Note that a preferred normalization factor is 255.

In the world today, the signals are either analog or digital. There are a lot of processors with dedicated internal hardware designed to deal with digital signals of high frequency/data rates. The processing of digital time domain signals (ex. HID—Human Interface Devices) are not a problem for today's processors.

A high degree of analog signals are high frequency in nature. Signals such as analog wired and wireless communications, that have uniformity in frequency(ies) and have low signal levels drove the creation of the DSP (Digital Signal Processor) style processor with it's powerful handle analog signals of low frequency, that are un-uniform in frequency nature and low in amplitude that exist predominately in the time domain. According to the present invention, the Fourier math is the domain of the DSP and frequency domain signal analysis and the statistical math would be the logical choice for time domain data analysis, in which the math involved is much simpler, and would not require a high end processor to accomplish.

The energy signal detection device of the present invention provides a method to be able to recover the low signal level data, wherein simply sampling the signal with an 8-10 bit ADC (Analysis Dynamic Control) will not work. The signal needs to be brought within the range of the ADC's operating voltage. The large DC offset the signal rides on needs to be handled so that the ADC's dynamic range is working on only the signal element.

For example, on an Encore XP Z8 part, the signal can be brought into one side of a differential ADC input. On the other side of the differential ADC input, a DC reference voltage (from PWM CCT or I/O controlled DAC ladder), that is 50 mV less than the steady state of the signal from the element, can be dialed up. This means the ADC will only measure the signal elements, plus the noise elements, plus 50 mV of DC. The differential ADC input also includes an internal ×20 gain amplifier. The ADC is a sigma delta converter that provides a high degree of accuracy for a tradeoff in sample/conversion speed. Internally the data is guaranteed to 10 bits of accuracy resolution, but by taking multiple samples and averaging them, the full 16 bits can be used, providing with a very accurate raw signal input that does not require any hardware pre-conditioning.

The ADC's resolution is 65535 steps over a 2 volt range. As the data are inputted and buffered, the maximum and minimum sample values are tracked. It is because the required number of floating point operations can be limited. By keeping the minimum and maximum readings, the data samples can be normalized back into 8 bit integer data without loosing resolution information, allowing the rest of the heavy data buffering to be done using less memory. If all data were left as floating point then the techniques would not be possible on this low end of a processor.

Referring to FIGS. 5A and SB, if the data above (signal +noise +DC component) are analyzed, it is found that it is normally distributed, or close enough. With normally distributed data, a shortcut can be used for calculating the standard deviation. It is known that 68.26% of the data will fall within 1 standard deviation of the mean, 95.46% of the data will be within 2 standard deviations, and 99.73% will fall within 3 standard deviations. In other words, by means of three standard deviations, 99.73% of all the data points are expected falling between the UCL (Upper Control Limit) and LCL (Lower Control Limit).

From control chart theory, the control limits for the data using simple math are generated. It is accomplished by means of a method including the steps as follows:

(i) Take a sample size and then generating sub groups within the sample.

(ii) Compute the averages of each sub sample.

(iii) Compute the range for each sub sample.

(iv) Compute the sample average as the average of all the sub sample averages.

(v) Compute the range average as the average of all the sub sample ranges.

(vi) Compute the control limits by taking the sample average and adding/subtracting the sample range averages multiplied by the A2 factor, wherein the A2 factor is a constant that is based on the sub sample size, and that the A2 factor saves the necessity of doing the actual standard deviation computation. It only works for normally distributed data. In other words, the above A2 factor is a quick (short cut) method for calculating standard deviations. It can only be used with the distribution of the data is normal (i.e. Gaussian/Bell Curve).

Referring to FIG. 6, statistically, it is known that if there are data points (sub group averages) that tend to gravitate to the area between 2 and 3 standard deviations from the center line, then an abnormality exists. From probability it can likewise be said an abnormality exist when 3 of 7 consecutive points lie in this region.

In order to use the control limits in real time, the present invention provides two different sample control limits at differing time intervals, so that it can use the current sub sample averages and check them against the control limits from an earlier time index. This requires the present invention buffer a fair amount of data. This is the reason the raw samples are normalized from floating point back to 8 bit data values. It is appreciated that the Encore XP Z8 has 1000 bytes of internal ram storage.

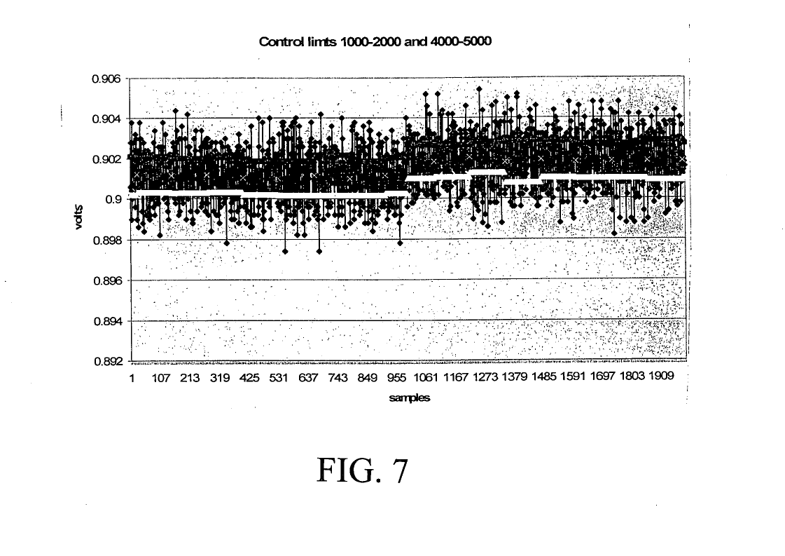

In the chart illustrated in FIG. 7, all that is graphed are the points from 1000 to 2000 in first half, and in the second half of the graph are the points from 1000 to 2000 in first half, and in the second half of the graph are the points from 4000 to 5000. It is noticed that more than 3 of 7 of window 2's sub window averages (central x's) all fall on the upper control limits of window 1 (upper lines). For larger signals the window 1 lower control limit will actually be larger than the window 2 upper control limit or vise versa depending on the direction of the energy swing. In either case, this constitutes a change in the stable steady state data system. This is one of the keys of the present invention.

A change in the steady state system means there is a change in the infrared energy being seen. The smaller the distance between the 2 sample windows, the less sensitive the algorithm will be to small changes in energy detection. The larger the distance the better it can detect small changes. Likewise the larger the sample window size is then the less sensitive to change the algorithm will be. This gives us the ability to have a lot of flexibility with pet immunity rejection. Large heat sources at far distances will be small in amplitude change but last longer over time, where small heat sources closer to the unit will also be small in amplitude, but will last shorter in time as it tends to cross more beams quicker.

Such data analysis of the present invention enables the dealing with any level of noise within the energy signal detection device without having to filter it. Noise is Gaussian in nature so the amount of noise will not affect the control limits for the energy signal detection device. The data remains normally distributed. This means it should be able to do away with the “pulse count” feature.

Another benefit of the present invention is the ability to detect a discontinuity in the data. This ability will be lost if the data are filted. A discontinuity could be attributed to an external influence such as RF energy, unstable power, electrical disturbances, etc.

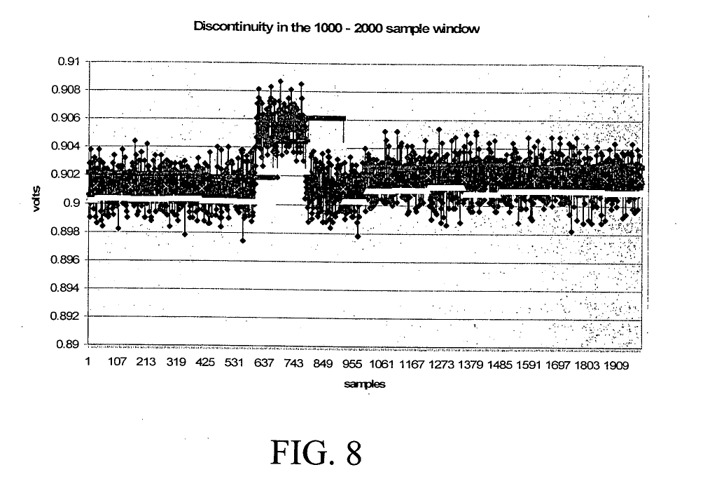

However, referring to FIG. 8, if at any time in either sample window there is a trend shift in the data outside the control limits of the sample window thereof, then this is not valid data from the element. The energy signal detection device can not behave this way. The conventional method of filtering and amplifying would see this external influence shift no differently then it would valid infrared energy moving quickly from one beam to another. In this case the energy signal detection device of the present invention can hold off any/all decision making until the input data returns to a stable state. If the data does not return to stability within a certain time, then the energy signal detection device can initiate a trouble condition or an alarm if no trouble state is supported.

In addition, as the ambient temperature gets closer to 35 degrees C. it becomes increasingly more difficult to detect the radiated infrared energy from a person and the surrounding background. Conventional detector will increase the gain the closer the temperature reaches 35 degrees. Once it goes beyond 35 degrees, it needs to reduce then gain as the difference between body temperature and room temperature starts to once again increase. Most detectors keep upping the gain in once direction only making these detectors extremely unstable and unreliable in hot environments.

The new algorithms ability to work with unamplified low level signals may negate the need to increase the signal gain altogether. If gain is indeed needed to keep detection reliability, then the Z8's on board temperature sensor is used to determine how close it is to 35 degrees. The gain is accomplished by adjusting the DC reference voltage on the ADC's reference input closer to the element input signal level. Therefore, it does not amplify the DC level but only more of the signal level and the Gaussian noise component. The data then remains in control and normally distributed with no additional circuitry influences. The algorithm in control and normally distributed with no additional circuitry influences. The algorithm then changes the sample window sizes so that the control limits can be tightened. This type of gain adjustment should allow for the same reliable detection performance regardless of temperature.

Also, the DC offset of the signal level will drift over time with variations in ambient temperature. Over its' operating range it can drift as much as 700 mVp-p. According to the preferred embodiment of the present invention, the energy signal detection device can dynamically adjust the ADC differential reference voltage to keep it at the 50 mV level from the signal. A long term average of the signal level needs to be kept so that periodic tracking of the DC shift due to temperature can be maintained. If this is not done the unit will loose sensitivity with temperature drift as the ADC will measure more offset and less signal.

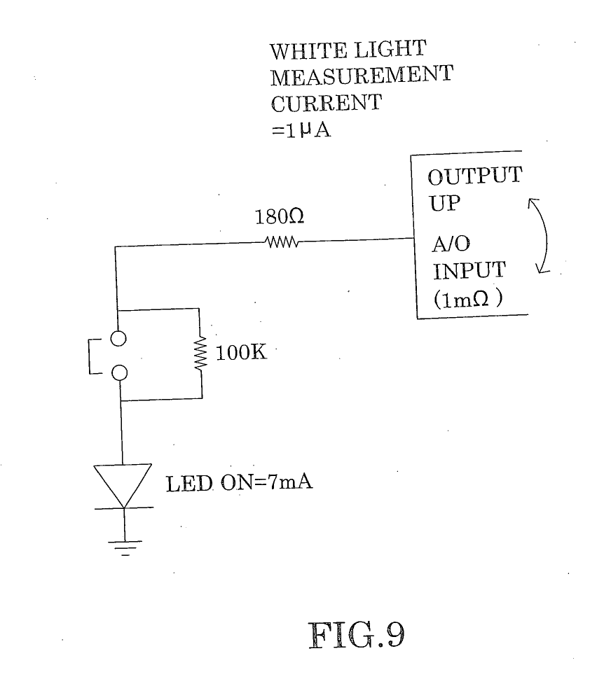

Referring to FIG. 9, the energy signal detection device of the present invention not only inherently reduce false alarm for distinguishable to noise and real signals, but also take white light as signal and analyze it to prevent false alarm. Generally, the PIR detector provides a LED 51 that illustrates the present of any motion detected. For some PIR detector, a jumper 52 is contained for the user to selectively turning on or off the LED 51. Since the LED 51 will create a voltage signal when a light sight on the LED 51, this LED 51 is utilized in the energy signal detection device of the present invention as a white light detector to detect white light, wherein it is unnecessary to know the exact intensity of the white light but merely required to detect any change of the white light and relative intensity.

According to the preferred embodiment of the present invention, referring to the FIG. 9, the energy signal detection device further comprises a resistor 53 having a relatively high resistance provided across the jumper 52 to stop the power to the LED 51 but make no block to sighting signal back for measurement, so that even though the user takes the jumper off, the resistor circuit maintains a reverse path between the LED and A/D input/output to receive voltage change. By means of such LED white light detection technology as disclosed above, it is a lot more reliable, cheaper and 10-100 times less power consuming than utilizing relay circuitry in the conventional motion detector.

More specifically, the operation of the data sampling of the present invention is elaborated as follows: initially, 20 sample input of the PIR of the ADC are taken, and 96 data samples are drawn to create a buffer. After that, one has to divide the buffer's data samples into windows, each having 20 data samples. After the buffer's data has been divided, one has to get the upper control limit (UCL), the lower control limit (LCL) of every 20-data sample, and the root means square for every 20-data sample to obtain an A-2 factor which will be kept constant, wherein the positive and negative values of the A-2 factor are the determinate of the UCL and the LCL respectively. The windows will be continuously updated within an ongoing time frame so that any signal change is taken into account. According to the preferred embodiment of the present invention, UCL =average+(A2 value×predetermined factor) while LCL=average−(A2 value×predetermined factor), where ‘average’is the average value of the sample data and the ‘predetermined factor’is pre-set for optimal range of data analysis, which is preferably embodied as the difference between the maximum value and minimum value of the data samples.

It is worth mentioning that statistically method is used to determine whether any change in the signal pattern is due to noise or a genuine alarm signal. For example, the statistical method is such that noise will not cause any change to UCL and LCL, while a genuine alarm signal will cause both values to change. Moreover, the UCL and LCL may be changed to account for different types of targets, environment in which the present invention operates, and ambient temperature. Consequently, the present invention is automatically adapted to the best statistically proportionality for determining the presence of genuine alarm signal.

From the forgoing descriptions, it can be shown that the above-mentioned objects have been substantially accomplished. The present invention provides the energy signal detection device and the method thereof for sensing physical movement in a detecting area, wherein the energy signal detection device comprises the integrated detecting processor 40 which is adapted to supplement a regulated DC signal to an output signal of the pyroelectric sensor 20 in the energy signal detection device so as to improve the quality of those portions of output signals corresponding with an actual physical movement within the detecting area for maximizing an overall performance of the energy signal detection device.

With the introduction of newer small processors having more computational horsepower and memory resources as well as on board peripherals, it is now possible to use other methods of signal processing other then the traditional root mean square approach of measuring the energy under the curve. With this statistical approach, which is typically used as a method to monitor and control process variations, we can gain greater control in making valid decisions on changes in analog signals that are predominately in the time domain. With the combination of the reduced hardware signal conditioning and the more powerful and flexible processing algorithm, it is now possible to overcome the short comings of the traditional PIR design while reducing the cost at the same time.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An energy signal detection device, comprising:
a pyroelectric sensor defining a detecting area and detecting energy radiation directed therewithin as an input signal which is converted into a DC signal as an output signal through said pyroelectric sensor, wherein said DC output signal has a real signal with low frequency and a noise signal mixed therewith;
a microprocessor, which comprises a Analysis Dynamic Control (ADC) converter, being arranged to receive said DC signal from said pyroelectric sensor for data processing so as to determine whether a target locating within said detecting area; and
an integrated detecting processor stripping out said DC signal from said pyroelectric sensor to control a DC level of said DC signal, such that said real signal is allowed to be processed in said microprocessor without data overflowing.

2. The energy signal detection device, as recited in claim 1, wherein said integrated detecting processor comprises a DC generator having the same DC resolution of said microprocessor, wherein said integrated detecting processor allows said microprocessor to use a small signal across a dynamic range thereof without said DC level being used up and overflowed.

3. The energy signal detection device, as recited in claim 1, wherein said microprocessor further comprises a signal analysis unit electrically connecting with said ADC converter for statistically analyzing said DC signal, wherein said signal analysis unit statistically collects a plurality of sample data from said DC signal via a time domain to dynamically control said sample data by itself, wherein a control range of said DC signal is determined from said sample data in such a manner that when said sample data falls within said control range, said sample data is considered as said noise signal to be discarded from said DC signal, so as to accurately process said real data with low frequency in said DC signal in said ADC converter.

4. The energy signal detection device, as recited in claim 2, wherein said microprocessor further comprises a signal analysis unit electrically connecting with said ADC converter for statistically analyzing said DC signal, wherein said signal analysis unit statistically collects a plurality of sample data from said DC signal via a time domain to dynamically control said sample data by itself, wherein a control range of said DC signal is determined from said sample data in such a manner that when said sample data falls within said control range, said sample data is considered as said noise signal to be discarded from said DC signal, so as to accurately process said real data with low frequency in said DC signal in said ADC converter.

5. The energy signal detection device, as recited in claim 3, wherein said microprocessor further comprises a differential input source electrically coupling with said pyroelectric sensor to measure a difference between two signals from said DC generator and said pyroelectric sensor.

6. The energy signal detection device, as recited in claim 4, wherein said microprocessor further comprises a differential input source electrically coupling with said pyroelectric sensor to measure a difference between two signals from said DC generator and said pyroelectric sensor.

7. The energy signal detection device, as recited in claim 4, wherein said microprocessor further comprises a temperature sensor for determining a temperature of said target with respect to an ambient temperature so as to control a sensitivity of said microprocessor.

8. The energy signal detection device, as recited in claim 6, wherein said microprocessor further comprises a temperature sensor for determining a temperature of said target with respect to an ambient temperature so as to control a sensitivity of said microprocessor.

9. The energy signal detection device, as recited in claim 6, wherein said microprocessor further comprises a signal amplifier amplifying said DC signal with said real signal before sending to said ADC converter.

10. The energy signal detection device, as recited in claim 8, wherein said microprocessor further comprises a signal amplifier amplifying said DC signal with said real signal before sending to said ADC converter.

11. The energy signal detection device, as recited in claim 9, wherein said pyroelectric sensor comprises a PIR detector utilized as a white light detector for detecting white light, so as to detect possible change of an intensity of said white light for spotting suspicious movement.

12. The energy signal detection device, as recited in claim 10, wherein said pyroelectric sensor comprises a PIR detector utilized as a white light detector for detecting white light, so as to detect possible change of an intensity of said white light for spotting suspicious movement.

13. The energy signal detection device, as recited in claim 11, wherein said ADC converter comprises a sigma delta converter which is capable of converting an input signal fed into a differential ADC input to a steady state output signal, wherein said output signal is guaranteed to 10 bits of accuracy resolution for providing accurate signal processing.

14. The energy signal detection device, as recited in claim 12, wherein said ADC converter comprises a sigma delta converter which is capable of converting an input signal fed into a differential ADC input to a steady state output signal, wherein said output signal is guaranteed to 10 bits of accuracy resolution for providing accurate signal processing.

15. A microprocessor for an energy detecting device having a DC signal, comprising:
a Analysis Dynamic Control (ADC) converter; and
a signal analysis unit electrically connecting with said ADC converter for statistically analyzing said DC signal, wherein said signal analysis unit statistically collects a plurality of sample data from said DC signal via a time domain to dynamically control said sample data by itself, wherein a control range of said DC signal is determined from said sample data in such a manner that when said sample data falls within said control range, said sample data is considered as a noise signal to be discarded from said DC signal, so as to accurately process a real data with low frequency in said DC signal in said ADC converter.

16. The microprocessor, as recited in claim 15, wherein said signal analysis unit comprises a data processor statistically determining said control range to form an upper control limit and a lower control limit, wherein a range between said upper and lower control limits is determined in term of numbers of standard deviation from said sample data within said time domain.

17. The microprocessor, as recited in claim 16, wherein said data processor is an n-bit processor statistically takes n sample data at one time to form a single sample for data analysis, so as to increase a resolution of said ADC converter by over sampling.

18. The microprocessor, as recited in claim 17, wherein said data processor is a 16-bit processor statistically takes sixteen sample data at one time.

19. The microprocessor, as recited in claim 15, further comprising a temperature sensor incorporating with said infrared sensor to control a sensitivity of said microprocessor.

20. The microprocessor, as recited in claim 18, further comprising a temperature sensor incorporating with said infrared sensor to control a sensitivity of said microprocessor.

21. The microprocessor, as recited in claim 19, wherein said ADC converter comprises a sigma delta converter which is capable of converting an input signal fed into a differential ADC input to a steady state output signal, wherein said output signal is guaranteed to ten bits of accuracy resolution for providing accurate signal processing.

22. The microprocessor, as recited in claim 20, wherein said ADC converter comprises a sigma delta converter which is capable of converting an input signal fed into a differential ADC input to a steady state output signal, wherein said output signal is guaranteed to ten bits of accuracy resolution for providing accurate signal processing.

23. A method of analyzing DC signal for ADC converter, comprising the steps of:
(a) statistically collecting a plurality of sample data from said DC signal via a time domain to dynamically control said sample data by itself;
(b) determining a control range of said DC signal from said sample data;
(c) discarding said sample data from said DC signal when said sample data falls within of said control range; and
(d) taking said sample data into account for processing in said ADC converter when said sample data falls out of said control range.

24. The method, as recited in claim 23, wherein said step (b) comprises the steps of:
(i) dividing said sample data of a predetermined sample size for generating sub groups within said sample size, wherein each of said sample returns a sample value;
(ii) determining an average of said sample value of each of said samples within each of said sub groups;
(iii) determining a range of said sample values of said samples within each of said sub groups;
(iv) determining said sample average as an average of all of said sample values of each of said sub groups;
(v) determining a range average as an average of all said ranges of said samples of each of said sub groups; and
(vi) determining control limits as said control range by taking a sample average and adding said range average and multiplied by an A-2 factor, wherein said A-2 factor is a constant that is based on said sample size for avoiding calculation of actual standard deviation of said sample.

25. The method, as recited in claim 24, wherein the step (a) further comprises a step of statistically taking a predetermined numbers of sample data at one time to form a single sample for data analysis, so as to increase a resolution of said ADC converter by over sampling.

26. The method, as recited in claim 23, wherein the step (b) further comprises a step of determining an upper control limit and a lower control limit of said control range, wherein a range between said upper and lower control limits is determined in term of numbers of standard deviation from said sample data within said time domain.

27. The method, as recited in claim 24, wherein the step (b) further comprises a step of determining an upper control limit and a lower control limit of said control range, wherein a range between said upper and lower control limits is determined in term of numbers of standard deviation from said sample data within said time domain.

28. The method, as recited in claim 25, wherein the step (b) further comprises a step of determining an upper control limit and a lower control limit of said control range, wherein a range between said upper and lower control limits is determined in term of numbers of standard deviation from said sample data within said time domain.

29. The method, as recited in claim 23, wherein the step (b) further comprises a step of controlling a range between said upper and lower control limits to control a sensitivity of sample data collection.

30. The method, as recited in claim 24, wherein the step (b) further comprises a step of controlling a range between said upper and lower control limits to control a sensitivity of sample data collection.

31. The method, as recited in claim 25, wherein the step (b) further comprises a step of controlling a range between said upper and lower control limits to control a sensitivity of sample data collection.

32. The method, as recited in claim 23, further comprising a step of normalizing said sample data which falls within said control range for said ADC converter.

33. The method, as recited in claim 28, further comprising a step of normalizing said sample data which falls within said control range for said ADC converter.

34. The method, as recited in claim 31, further comprising a step of normalizing said sample data which falls within said control range for said ADC converter.

35. The method, as recited in claim 28, wherein a predetermined number of data samples is used for determining said control range which is a difference between said upper control limit and said lower control limit, wherein said A-2 factor is determined by a root means square of every sample value.

36. The method, as recited in claim 31, wherein a predetermined number of data samples is used for determining said control range which is a difference between said upper control limit and said lower control limit, wherein said A-2 factor is determined by a root means square of every sample value.

37. The method, as recited in claim 34, wherein a predetermined number of data samples is used for determining said control range which is a difference between said upper control limit and said lower control limit, wherein said A-2 factor is determined by a root means square of every sample value.
